(19) United States
(12) Patent Application Publication
(10) Pub. No.: US 2026/0024359 A1
(43) Pub. Date: Jan. 22, 2026

(54) DICE VALUE RECOGNITION AND COMMUNICATION SYSTEM

(71) Applicant: Jerrell Harris, Chicago, IL (US)

(72) Inventor: Jerrell Harris, Chicago, IL (US)

(21) Appl. No.: 18/778,235

(22) Filed: Jul. 19, 2024

(51) Int. Cl. G06V 20/60; A63F 9/04; A63F 9/24

(52) U.S. Cl. CPC G06V 20/60; A63F 9/0402; A63F 2009/2435; A63F 2009/2494

(57) ABSTRACT

A dice value recognition and communication system for determining dice rolls and communicating them to remote players includes at least one playing die, a position sensing system to determine rolled values of the playing die, and a player computing device. The player computing device receives rolled value data from the position sensing system and communicates it to other player computing devices via a network. The position sensing system may include sensors mounted in the playing dice and sensors in a rolling tray on which the playing dice are to be rolled.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to remote dice game system and more particularly pertains to a new remote dice game system for determining dice rolls and communicating them to remote players.

### (2) DESCRIPTION OF RELATED ART INCLUDING INFORMATION DISCLOSED UNDER 37 CFR 1.97 AND 1.98

The prior art relates to remote dice game systems, including myriad systems which simulate dice rolls through random number generators or other random selection algorithms which electronically simulate the results of a dice roll.

U.S. Pat. No. 6,331,145 discloses a die which includes one or more sensors for determining a value of the die when it has been rolled and a wireless transmitter for transmitting the value to a remote device. The sensors are disclosed to be Radio Frequency Identification (RFID) tags, and the value may be determined by sensing which RFID tag is closest to a surface on which the die is rolled.

U.S. Pat. No. 8,210,924 discloses a die with RFID tags arranged to form a polygon, the orientation of which may be determined by a system configured to detect the locations of the RFID tags. The orientation of the polygon is reflective of the orientation of the die, which facilitates the system in determining what value was rolled using the die.

However, the prior art fails to disclose a system which uses cameras implemented on dice and on a rolling tray to determine rolled values of the dice and transceivers to transmit the rolled values to a remote electronic device for use in playing a dice game. Such a system may be advantageous over the prior art by providing multiple visual means of determining values of rolled dice and communicating them to remote players.

### (h) BRIEF SUMMARY OF THE INVENTION

An embodiment of the disclosure meets the needs presented above by generally comprising a playing die with a die body having a plurality of faces, wherein each face has indicia which indicate a value associated with the face. A position sensing system is provided which is configured to determine a rolled value of the playing die. “Rolled value” is used to refer to the value indicated by the indicia of the face of the playing die which faces upwardly after the playing die comes to rest due to being thrown or rolled. The position sensing system may comprise a die position sensor mounted in the playing die, external position sensors mounted in a tray or other apparatus onto which the playing die is to be rolled, or any other suitable sensor arrangement. A player computing device is provided which is programmed to wirelessly communicate with the position sensing system. The player computing device is also programmed to communicate with other player computing devices over a network for execution of a game application using rolled values of the playing dice.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective kit view of a dice value recognition and communication system according to an embodiment of the disclosure.

FIG. 2 is a front view of a rolling tray of an embodiment of the disclosure.

FIG. 3 is a perspective view of a die of an embodiment of the disclosure.

FIG. 4 is a side view of a die of an embodiment of the disclosure.

FIG. 5 is an in-use view of an embodiment of the disclosure.

FIG. 6 is a block diagram of an embodiment of the disclosure.

### (j) DETAILED DESCRIPTION OF THE INVENTION

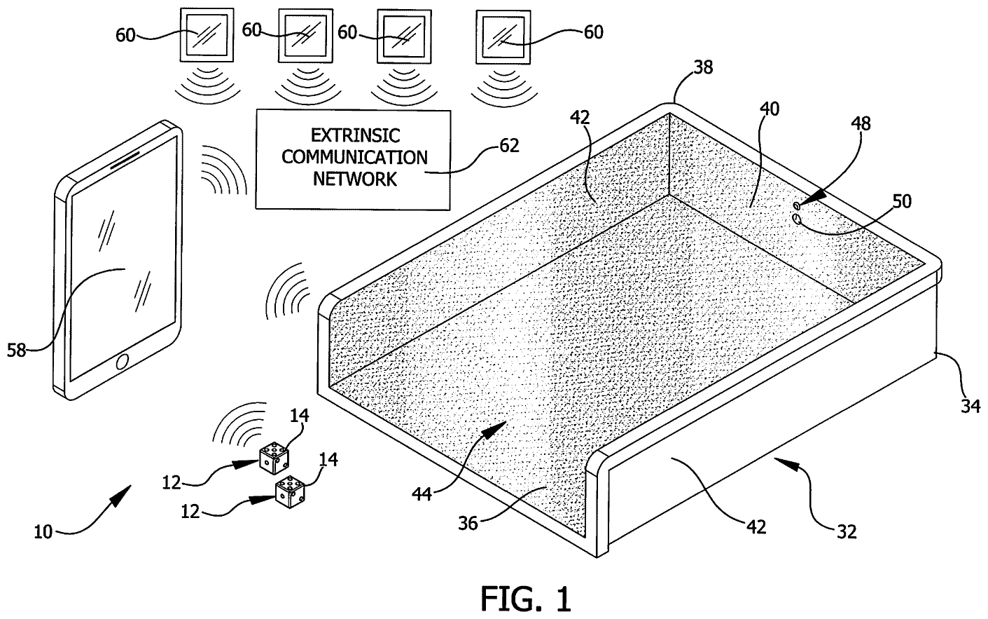

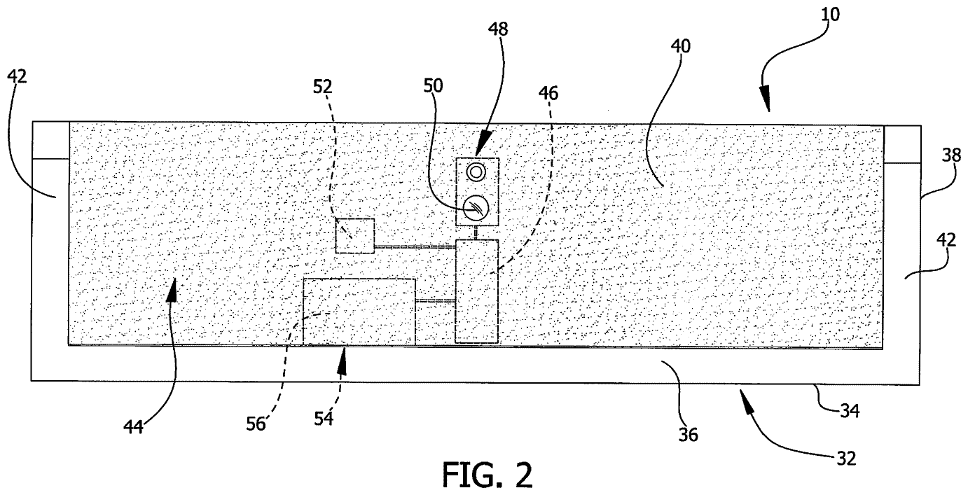

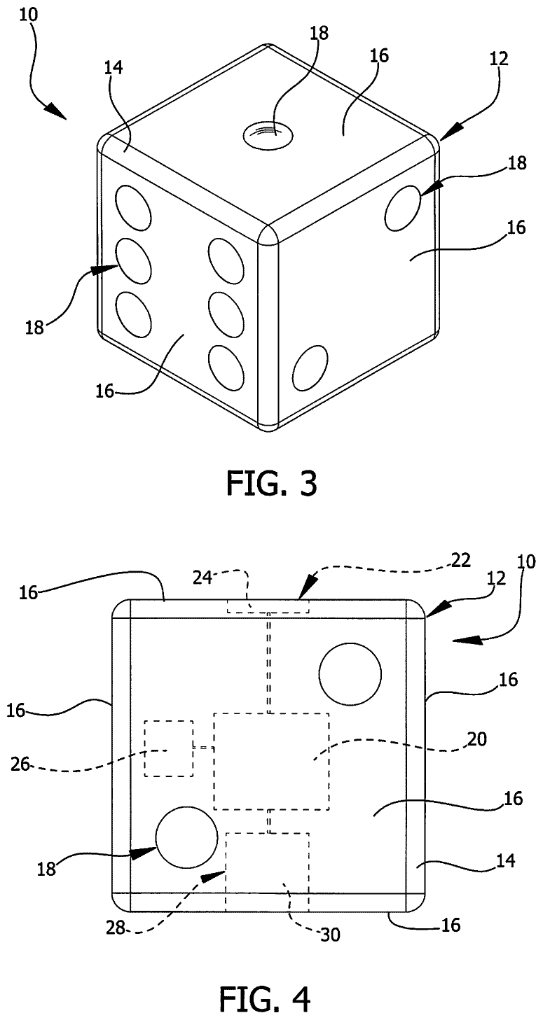

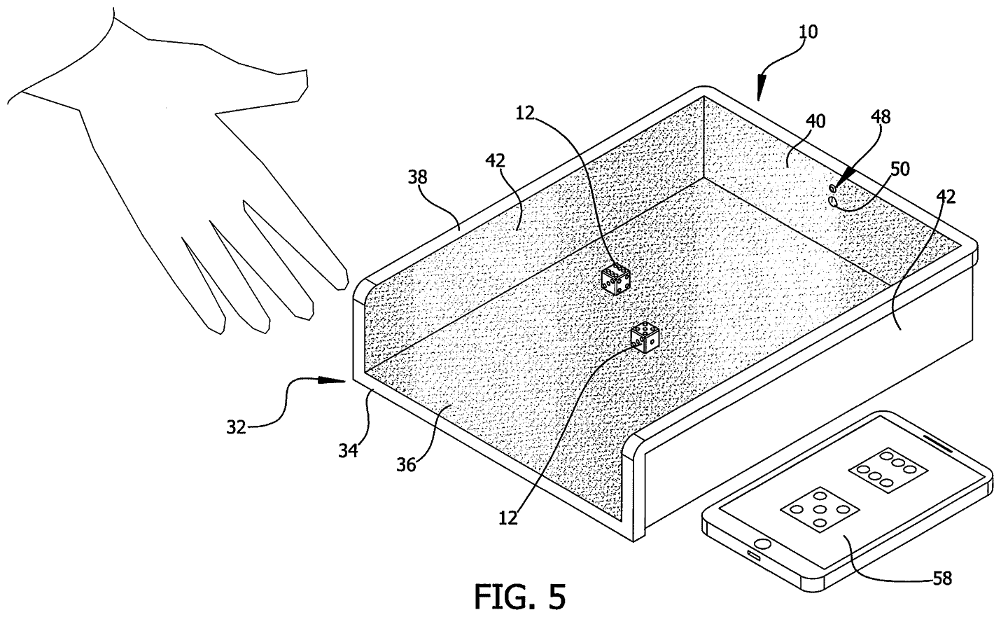

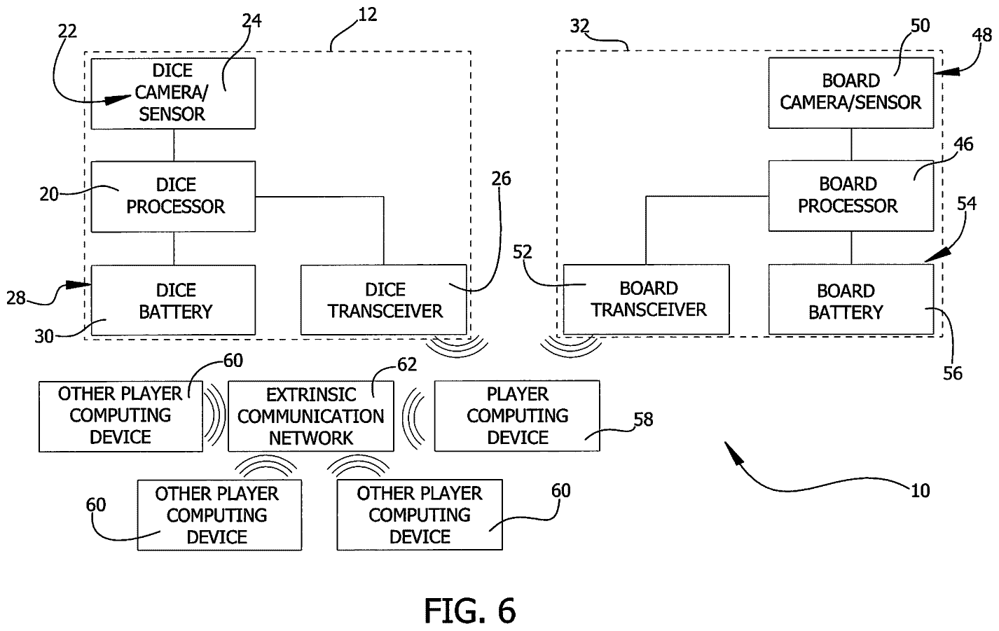

With reference now to the drawings, and in particular to FIGS. 1 through 6 thereof, a new remote dice game system die bodying the principles and concepts of an embodiment of the disclosure and generally designated by the reference numeral 10 will be described.

As best illustrated in FIGS. 1 through 6, the dice value recognition and communication system 10 generally comprises a pair of playing dice 12, where each playing die 12 of the pair of playing dice 12 comprises a die body 14 with a plurality of faces 16, and each face 16 has indicia 18 which indicate a value associated with the face 16. The playing dice 12, such as those depicted in the Figures, may be of common type: cubes with six faces which are numbered one through six, such as the type which are used in a game of craps. However, any number of faces 16 may be used, and the indicia 18 of the faces 16 may indicate any sort of value. For example, the faces 16 may indicate various numerical values, colors, shapes, words, symbols, or the like. The faces 16 may be planar or may have three-dimensional shapes. The indicia 18 may be printed, embossed, impressed, or otherwise expressed in a visually identifiable manner. In short, any variant of die may be used for each playing die 12 which, when tossed onto a surface, is made to come to rest such that one of the faces 16 is directed upwardly to indicate a rolled value of the playing die 12. Any suitable quantity of playing dice 12 may also be used in other embodiments.

Each playing die 12 further comprises a die processor 20 mounted in the die body 14, a die position sensor 22 coupled to the die body 14 and operatively coupled to the die processor 20, a die transceiver 26 mounted in the die body 14 and operatively coupled to the die processor 20, and a die power supply 28 electrically coupled to the die processor 20. The die processor 20 is programmed to determine a rolled value of the playing die 12 via the die position sensor 22. The die position sensor 22 comprises a die camera 24 which faces outwardly from the playing die 12 from one of the faces 16 of the playing die 12 to see the environment around the playing die 12. The die processor 20 analyzes images captured via the die camera 24 to determine if the playing die 12 is being thrown, has recently come to rest after being thrown, and what the rolled value of the playing die 12 is upon coming to rest. In other embodiments, the die position sensor 22 may comprise one or more accelerometers, inclinometers, or other suitable sensor. The die power supply 28 comprises a die battery 30, which may be chargeable via a port or wirelessly or replaceable via an access panel or the like. In other embodiments, the die power supply 28 may be a capacitor or other suitable energy storage device.

A rolling tray 32 is provided for rolling the pair of playing dice 12 thereon. The rolling tray 32 comprises a tray body 34 with a bottom wall 36 and a perimeter wall 38, in which the perimeter wall 38 is coupled to and extends away from the bottom wall 36. The perimeter wall 38 has a rear section 40 and a pair of lateral sections 42, wherein the rear section 40 is coupled to and extends between the pair of lateral sections 42. The perimeter wall 38 defines a front gap 44 opposite the rear section 40 between the pair of lateral sections 42, facilitating the playing dice 12 being thrown toward the rear section 40 through or over the front gap 44. The rolling tray 32 may have a felt or other soft lining over interior sides of the bottom wall 36 and the perimeter wall 38 to facilitate cushioning the playing dice 12 when the playing dice 12 are thrown onto the rolling tray 32.

A tray processor 46, a tray position sensor 48, a tray transceiver 52, and a tray power supply 54 are mounted in the tray body 34. The tray position sensor 48 is operatively coupled to the tray processor 46 and is programmed to determine rolled values of the playing dice 12 when the playing dice 12 are rolled onto the rolling tray 32 via the tray position sensor 48. The tray position sensor 48 comprises a tray camera 50 which is positioned on the rear section 40 of the perimeter wall 38. The tray processor 46 determines via images captured by the tray camera 50 when the playing dice 12 are being rolled onto the bottom wall 36 of the tray body 34, when the playing dice 12 come to rest, and what rolled values of the playing dice 12 are which come to rest. The tray transceiver 52 is operatively coupled to the tray processor 46. The tray power supply 54 electrically powers the tray processor 46. The tray power supply 54 comprises a tray battery 56 which may be chargeable or replaceable. In other embodiments, the tray power supply 54 may be a capacitor or other energy storage device or may be an electrical cord that couples the tray power supply 54 to an external power source.

The die position sensors 22 and the tray position sensors 48 may be used in conjunction with each other to determine and verify the rolled values of the playing dice 12 upon being rolled onto the bottom wall 36 of the tray body 34. In some embodiments, the die position sensors 22 and the tray position sensor 48 may be components which determine the orientations of the playing dice 12 through triangulation, trilateration, magnetic fields, or any other suitable position detection means. In other embodiments, only the die position sensors 22 or only the tray position sensor 48 is used.

A player computing device 58, such as a smartphone, a computer, a tablet, or other suitable device, is programmed to wirelessly communicate with the die transceiver 26 of each playing die 12 of the pair of playing dice 12 and with the tray transceiver 52. The player computing device 58 receives the rolled values of the playing dice 12 from the die transceivers 26 and the tray transceiver 52. The player computing device 58 is programmed to communicate with other player computing devices 60 over a network 62 for execution of a game application using rolled values of the playing dice 12. The network may include one or more computer networks, wireless radio networks, the Internet, and the like.

In use, the dice value recognition and communication system 10 is used to play a game, such as craps or any other dice game, remotely with other players that have other instances of the dice value recognition and communication system 10. The system 10 ensures that individuals playing the game are transmitting correct rolled values of the playing dice 12 to each other and enables the individuals to enjoy the tactile nature of tangible dice versus using random number generators or other virtual dice simulations. The game application may keep track of scores, bets, and other game data and may prompt the players of the game to roll the playing dice 12. Images of the playing dice 12, including videos of the playing dice 12 being thrown onto the rolling tray 32, may be transmitted to other players in some instances.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dice value recognition and communication system comprising:
a playing die comprising a die body, the die body having a plurality of faces, each face having indicia which indicate a value associated with the face;
a position sensing system configured to determine a rolled value of the playing die; and
a player computing device programmed to wirelessly communicate with the position sensing system, the player computing device being programmed to communicate with other player computing devices over a network for execution of a game application using rolled values of the playing dice.

2. The system of claim 1, wherein the position sensing system includes:
a die processor mounted in the die body;
a die position sensor coupled to the die body and operatively coupled to the die processor, the die processor being programmed to determine the rolled value of the playing die via the die position sensor;
a die transceiver mounted in the die body and operatively coupled to the die processor, the die transceiver being configured to wirelessly communicate with the player computing device; and
a die power supply electrically coupled to the die processor;

3. The system of claim 2, wherein the die position sensor comprises a die camera.

4. The system of claim 2, wherein the die power supply comprises a die battery.

5. The system of claim 1, further comprising:
a rolling tray for rolling the pair of playing dice thereon, the rolling tray comprising a tray body; and
wherein the position sensing system comprises:
a tray processor mounted in the tray body;
a tray position sensor coupled to the tray body and operatively coupled to the tray processor, the tray processor being programmed to determine the rolled value of the playing die when the playing die is rolled onto the rolling tray via the tray position sensor; and
a tray transceiver operatively coupled to the tray processor, the tray transceiver being configured to wirelessly communicate with the player computing device.

6. The system of claim 5, wherein the tray position sensor comprises a tray camera.

7. The system of claim 6, wherein:
the tray body of the rolling tray comprises a bottom wall and a perimeter wall, the perimeter wall being coupled to and extending away from the bottom wall; and
the tray position sensor is positioned on the perimeter wall.

8. The system of claim 7, wherein the perimeter wall has a rear section and a pair of lateral sections, the rear section being coupled to and extending between the pair of lateral sections, the perimeter wall defining a front gap opposite the rear section between the pair of lateral sections.

9. The system of claim 5, wherein the position sensing system further comprises a tray power supply electrically coupled to the tray processor.

10. The system of claim 9, wherein the tray power supply comprises a tray battery.

11. A dice value recognition and communication system comprising:
a pair of playing dice, each playing die of the pair of playing dice comprising:
a die body having a plurality of faces, each face having indicia which indicate a value associated with the face;
a die processor mounted in the die body;
a die position sensor coupled to the die body and operatively coupled to the die processor, the die processor being programmed to determine a rolled value of the playing die via the die position sensor, the die position sensor comprising a die camera;
a die transceiver mounted in the die body and operatively coupled to the die processor; and
a die power supply electrically coupled to the die processor, the die power supply comprising a die battery;
a rolling tray for rolling the pair of playing dice thereon, the rolling tray comprising:
a tray body, the tray body including a bottom wall and a perimeter wall, the perimeter wall being coupled to and extending away from the bottom wall, the perimeter wall having a rear section and a pair of lateral sections, the rear section being coupled to and extending between the pair of lateral sections, the perimeter wall defining a front gap opposite the rear section between the pair of lateral sections;
a tray processor mounted in the tray body;
a tray position sensor coupled to the tray body and operatively coupled to the tray processor, the tray processor being programmed to determine rolled values of the playing dice when the playing dice are rolled onto the rolling tray via the tray position sensor, the tray position sensor comprising a tray camera, the tray position sensor being positioned on the rear section of the perimeter wall;
a tray transceiver mounted in the tray body and operatively coupled to the tray processor; and
a tray power supply electrically coupled to the tray processor, the tray power supply comprising a tray battery; and
a player computing device programmed to wirelessly communicate with the die transceiver of each playing die of the pair of playing dice and with the tray transceiver, the player computing device being programmed to communicate with other player computing devices over a network for execution of a game application using rolled values of the playing dice.
